(19) United States
(12) Patent Application Publication
(10) Pub. No.: US 2012/0109689 A1
(43) Pub. Date: May 3, 2012

(54) Support System for Improved Quality Healthcare

(76) Inventor: Jason Lee, Los Alamitos, CA (US)

(21) Appl. No.: 13/281,724

(22) Filed: Oct. 26, 2011

Related U.S. Application Data
(60) Provisional application No. 61/407,640, filed on Oct. 28, 2010.

(51) Int. Cl. G06Q 50/24

(52) U.S. Cl. 705/3

(57) ABSTRACT

The present invention, defined as MEGICS (Medical+Logics), has been developed in order to improve quality of care and enhance the efficiency of operation of healthcare facilities and providers. When front-line healthcare doctors and nurses make various clinical decisions, MEGICS management system can provide them with relevant clinical knowledge in a timely manner. MEGICS management system can, therefore, increase the level of user satisfaction and provide patients with better quality of healthcare services. The Inventor believes that the present invention, MEGICS, can penetrate a new market and be easily adopted by healthcare facilities, due to its flexible system structure, experience-based approach, and user-friendly features.

### CROSS REFERENCE TO RELATED APPLICATIONS

This non-provisional patent application claims priority to U.S. provisional patent application Ser. No. 61/407,640 filed on Oct. 28, 2010 entitled “Support System for Improved Quality Healthcare”, the entire disclosure of which is hereby incorporated by reference in its entirety.

### FIELD OF THE INVENTION

The present invention relates to a healthcare management system. More specifically the present invention relates to a series of newly designed healthcare software and hardware platform.

### BACKGROUND OF THE INVENTION

The importance of reducing adverse drug events (ADEs) and prescription-related errors is well recognized in the healthcare field. Such cases have led to significant consequences impacting the patients' well being and have subsequently raised healthcare costs and compromised the efficiency of healthcare facility operations. Raised concerns among the healthcare providers have generated interest in the adoption of a Clinical Decision Support System (CDSS). It is reputed that a supplementary CDSS in a Computerized Physician Order Entry (CPOE)/Electronic Medical Record (EMR) system can improve the overall safety, quality and cost-effectiveness of healthcare services. Additionally, technical advancements in Healthcare Information Systems (HIS) of the healthcare facilities have improved the implementation of basic point-of-care (POC) in recent years.

The Inventor believes that the adoption of a CDSS in the healthcare industry can address the present concerns of ADEs and prescription-related errors shared among many healthcare providers.

### SUMMARY OF THE INVENTION

The present invention, defined as a MEGICS (combination of ‘Medical’ and ‘Logics’) has been in development since 2007 with the goal to improve quality of care and enhance the efficiency of healthcare facility operations. When front-line healthcare professionals must make various clinical decisions, MEGICS can provide them with relevant clinical knowledge in a timely manner. MEGICS can, therefore, not only provide user satisfaction, but also empower medical staff to provide the patients with better quality services. The user-oriented outcome with refined drug analysis will help hospital or clinic personnel make informed healthcare decisions and improve healthcare delivery, thereby provide the high-integrity, evidence-based service. The Inventor believes that the present invention, MEGICS, can penetrate a new market and be easily adopted by the hospitals or clinics due to its flexible system structure, experience-based approach, and user-friendly features.

The present invention, MEGICS, can be easily utilized and applied to various platforms through flexible modules. There will be very minimum risk for error in logic presentation, as it provides an Application Program Interface (API)/Software Development Kit (SDK) through the network. It also offers the real-time logic and information through live updates at the established database.

MEGICS has the flexibility of presenting outputs in multiple formats, such as XML, HTML, and TEXT. Its User Interface (UI) can be customized based on its own CPOE requirements, and can be integrated with any kind of drug database currently in operation.

The MEGICS software application can be developed on customer-specific configurations and installed on any local server system. The MEGICS application can also be further expanded via a Local Area Network (LAN) or the Internet while remaining cognizant of the risk for security breaches by continuously updating the information database. Log analysis will enable statistical analysis of overall aspects of operations.

Through its adaptability, MEGICS can be seamlessly integrated into the user's present environment to provide improved outcomes for healthcare service.

Purpose of Development

MEGICS is a management system solution that enables the physicians to offer enhanced medical services by providing them with real-time access to necessary patient information through an automated module. The MEGICS software application is a medical informatics service that will include information related to the provision of various medical services including treatment, patient education, and prescription medication. Through the MEGICS management system, important, but easily overlooked, details will not be excluded in a physician's decision-making process, as the MEGICS application will provide all relevant reports to the user on a real-time basis. This will eventually reduce the potential cause for medical errors and accidents.

It provides the necessary information to users on a real-time basis while interacting with the patients; and

It provides an auditing function for prescribing medication on a real-time basis which will minimize the number of prescription-related complications.

In an environment involving various medical service providers (such as clinics, hospitals, etc.) who may use multiple approaches (different standard codes, etc.) of manipulating patient-related content based on their individual needs (e.g. each general hospital can use a different code even for the same drug, aspirin.), the MEGICS management system establishes an encompassing platform for communication compliant with international and local standards. This will be accomplished through the use of a gateway service that allows various content providers to deliver information to medical service providers or patients more easily by adopting the standard program language.

For example, when prescribing a drug, the MEGICS application displays links to general prescribing information (non-patient-specific) including: 1) contraindications, adverse effects, adjustments for age/weight/lab results, 2) weight-based dose for pediatric use, 3) information about foods that may adversely interact with prescribe drug, 4) dosage guidance based on age, possibility of pregnancy, indication, drug utilization restrictions, etc. and 5) high-specificity therapeutic duplication.

When the user formulates a diagnosis, the MEGICS application will offer a Critical Pathway (CP)/Guideline to determine the optimum treatment for the described symptoms.

Expected Benefits

Real-time access to relevant information during patient interaction.

Prevention of prescription medicine-related complications through verification of drug-patient interactions.

Avoidance of emergency situations as the application will anticipate and deliver urgent alerts (e.g. prohibition of medication due to serious side effects in patient's body system) immediately.

Gateway for information exchange among different medical information systems.

Presentation of applicable clinical knowledge to the right person at the right time to make optimal care decisions.

Live updates will enable decision-making based on most updated information on drugs, patients, and protocol.

It can prevent serious errors or adverse events by utilizing proactive alert and guideline system.

Improved personalization of care for individual patients.

Clear prescription guidance based on age, gender, weight, and allergy to drug or food.

Reinforcement of compliance with accreditation and regulatory requirements.

### BRIEF DESCRIPTION

This MEGICS management system will act as intermediary to support related functions between drug information and insurance information by connecting with the mainframe system of the hospitals. MEGICS management system can be also applied to the computer system of individual clinics. Its main system structure will be to attach various modules and information resources to the mainframe without increasing the burden to operational performance. It will also simplify the integration process and substantially save time and cost of installation.

Characteristics of MEGICS

1) Interoperability

2) Portability

Expandable Modules
a) Drug Utilization Review (DUR)
b) Drug Information Service (DIS)
c) Diagnostic Equipment (DE) (ex. PillCam Capsule for Endoscope)
d) Insurance Real-Time Screening
e) External Resources (Databases, Journals & Web Sites)
f) Hospital Internal Depository
g) Mobile Application

Possible Modules
a) MEGICS Messenger: personal CDSS
b) MEGICS DIS: Intranet for outside drug database
c) MEGICS DE: Intranet for diagnostic service
d) MEGICS Drug: Supporting system for drug prescriptions
e) MEGICS Net: will provide the portal information
f) MEGICS DUR: Intranet module for real-time review and management of drug prescriptions
g) MEGICS PRO: Intranet module for hospital management information
h) An optional module to receive the test results from outside vendors when test samples are outsourced.

System Structure

MCMS (Medical Contents Management System)
Medical information (disease information, drug information, etc.) management system

It structuralizes the content provider's information and stores it in the database.

MIGS (Medical Information Gateway Service)

The present invention collects the information code of each institution (by providing a managing tool to each provider) and archives the information of each version.

The present invention standardizes the collected information and presents it a uniform format.

a) The present invention develops its own standard that briefly summarizes the existing standards.

b) The present invention supports the guidelines of different international institutions for standards such as HL7, ISO/TC 215, CEN/TC 251, etc.

The present invention supports information mapping service for information exchange between medical service providers.

a) The present invention collects medical codes used by each institution online and establishes connections among related codes.

b) The present invention maps the collected codes to recognizable codes (e.g. FDA approval numbers). For information that cannot be automatically mapped, it provides a managing tool so that an expert may perform the mapping manually.

CDSM (Clinical Decision Support Module)

Medical information: provides information on medical conditions and drugs (by product and by ingredient)

Prescription check: The present invention provides modules related to each drug such as interaction check (Drug-Drug, Drug-Food, Drug-Disease, etc.), dosage check (by ingredient and by product), duplicate prescription check, drug allergies check, etc.
a) Interactions (Drug-Drug, Drug-Food, Drug-Diseases, etc.)
b) Drug Identification Report
c) Dosage Alert (by prescription guidelines)
d) Duplicate Alert (duplicate prescription check)
e) Allergy Alert (hypersensitivity reaction cross check)
Patient education: Patient education materials including drug information, medication guide, etc.
a) Drug & Disease Information for Patient (Summary)
b) Medication Guide (Patient medication guide)

Service Diagram

System Information

Building Medical Information Database with MCMS

The present invention collects medical information from specialized medical journals, database companies, or public resources; allows the collected information to be edited by medical service providers such as physicians, pharmacists, nurses, etc.; and builds a customized and structuralized medical contents database based on the repackaged information.

The present invention builds and manages a database integrated with standard medical codes including FDA, HL7, ICD-10, etc., FDA approved drug information, and treatment-related information.

The present invention maps the standard code of each institution already in place in its unique database to MEGICS' own code, and builds a base database for the information gateway.

The present invention regularly extracts the information from the structuralized medical contents database, generates a service database for MIGS and CDSM services, and updates users.

The following information database will be built and continuously updated as services are provided:

a) Disease Information

b) Drug(Generic, Product) Information

c) Medication Guide

d) Interaction (Drug-Drug, Drug-Food, Drug-Disease)

Database

The present invention is prepared for an environment where various items can be added and changed by storing the text-based information in an easily adaptable XML Document format.

The present invention assigns a unique item code with a serial number to all contents.

Major Items for Drug Data Management

Drug Information

Since the information associated with a single drug item is provided in various ways, it is more efficient to manage the information by the following four levels: 1) Information at product level, 2) Information at packaging level, 3) Information at single ingredient level, and 4) Information at compound ingredient level.

Interaction

In the management of the interaction data, the database first bundles categories of interactions by class, then manages and outputs the information.

For example, for Information on Drug-Drug Interaction, the database will verify the information in the order of: Product1→Generic1→Generic Class1<−>Generic Class2←Generic2←Product2, then output the requested information.

Collecting Drug Information

The present invention develops a managing tool for drug information such as dynamic Wikipedia-type format. The present invention purchases relevant information from references to add to the database or edit existing information to compile a master information database.

### REFERENCES

FDA Approval Letter: FDA approval information open to the public.
Insert paper: Explanation letter provided by pharmaceutical companies.
Major drug information resources
a) Thomson Reuters Micromedex
   (http://www.micromedex.com)
b) UpToDate (http://uptodate.com)
c) AHFS Drug Information
   (http://www.ahfsdruginformation.com)
d) Lexicomp—Drug Information Handbook
   (http://www.lexi.com)
e) Yahoo Health

Medical Information Gateway Service (MIGS)

The present invention collects the standard codes that are publicly accessible or can be redistributed, builds a database, and provides them to the user. It also manages and retains the mapping information comprised of different codes used by each institution and provides a data relaying service that enables data exchange among users.

The user can manage its own code at the facility through the administrative tool that edits and manages the Private Medical Contents Code (user's own code). By providing the MEGICS CODE table, it enables the user to map the code manually.

When managing each user's code, if a mapping of a standard code already exists, the user may utilize a function that enables automatic mapping for this code.

For example, in the case of a drug code, if the user uses a FDA approval number, it is possible to map the approval number to the MEGICS CODE for that particular drug.

It is possible to search for information from other facilities by using the above mapping tool. This provides a service that enables information exchange between different systems or between different services.

For example, when patient examination data is remotely read by a user other than a person who ordered the examination, such as that of a video capsule endoscopy of Pillcam, it is possible to formulate a service to deliver the examination data to the accessing user and send the results through MEGICS using the patient's identification number to the patient.

Database Table. The internal tables in the database are formed to store data in rows and columns to represent logical and relational database. For examples, MIGS can contain a) CODE type table with column fields of generic code as unique key and description and b) Code map table with fields of generic code (key), private code (key), MEGICS assigned content ID and private generic code (key). CDSM can contain Code type table with field item codes (key) and content. From here, data will be searched with indexing of item code, keyword type and keyword. Content types will be listed such as REF (reference for classification), DIS (Disease Information), PRD (Drug Product Information) and GEN (Generic Information).

By synchronizing the database of the mapping information with the MEGIS Main Center (MCMS) on a real-time basis, it enables the MIGS to play a role of an index server.

Individual contents for sharing are stored in the local server of each facility. Data may be requested by users at other certified facilities. Whenever this request is received, it will first require an approval of the authorized person. MEGICS will use electronic signature and Public Key Infrastructure (PKI)-based document codification.

Clinical Decision Support Module (CDSM)

It provides an output that will display the drug (both of drug name and components) information as requested by the user. For the communication of such information, the system uses MIGS.

Response

a) It uses a web-based service (SOAP communication tool) for all the communication.

b) It guarantees the conformity between different types of platforms by providing all data in the XML format.

c) It provides a style sheet related to XML documents (in the form of HTML page) for convenience.

d) As for services that require reports such as patient medication guide, drug identification report, etc., MEGICS provides a reporting tool that enables an immediate output, separate from the XML output.

CDSM Integration Diagram

Database Table

The internal tables in the database are formed to store data in rows and columns to represent logical and relational database. For examples, MIGS can contain a) CODE type table with column fields of generic code as unique key and description and b) Code map table with fields of generic code (key), private code (key), MEGICS assigned content ID and private generic code (key). CDSM can contain Code type table with field item codes (key) and content. From here, data will be searched with indexing of item code, keyword type and keyword. Content types will be listed such as REF (reference for classification), DIS (Disease Information), PRD (Drug Product Information) and GEN (Generic Information).

The present invention stores all contents using MEGICS codes and separately manages data that requires a quick response in a local database.

The present invention utilizes a separate index table for the search engine.

Required Technologies

a) Medical Standard—Medical standards and code systems such as HL7, CDISK, ICD-10, etc.

b) Rule-Based Database

The MEGICS management system will utilize the rule engine to build a database for script-based logic.

A rule engine is a software system that executes one or more operational rules in a runtime production environment. The rules may come from the legal environment, business policies, or other sources. A business rule system enables these business policies and other operational decisions to be defined, tested, executed and maintained separately from application code.

Rule engine software is commonly provided as a component of a business rule management system which, among other functions, provides the ability to: register, define, classify, and manage all the rules, verify consistency of rules definitions, define the relationships between different rules, and relate some of these rules to IT applications that are affected or need to enforce one or more of the rules:

The rule will basically consist of rule editing, API module and database. There are various methods to record the rules by utilizing Script such as JavaScript, C#, and Arden Syntax. The MEGICS management system will employ a new approach of HL7 by benchmarking Arden Syntax.

If the medical rules are requested during the operation of the MEGICS management system, the software system will provide the user with the medical rules to be applied to the present service environment. This Medical Rule Engine will consist of three components: 1) Medical Rule Management System, 2) Medical Rules database, and 3) Medical Rules Engine Application Programming Interface.

Applicable Rules

There will be several types of rules to be applied: 1) dosage check, 2) interactions check, 3) duplicate check, and 4) error in diagnostics and treatment check. These rules will be an integral part of the MEGICS management system, as they will ensure the production of reliable outputs from the database. These rules will be expanded during the course of operations in accordance with the user's demand.

c) Planned Programming Tools

The MEGICS management system can be built by web-based application (.net framework, C#, JavaScript, Ajax, Web Service).

Data Handling: Oracle, MS-SQL, XML or others

API offering: COM, DLL and others.

### BRIEF DESCRIPTION OF THE DRAWINGS

FIG. 1 is a perspective view of MEGICS Architectural Overview of the present invention.

FIG. 2 is a perspective view of Clinical Decision Support Module (CDSM) Integration Diagram.

FIG. 3 is a perspective view of MEGICS Service Diagram.

FIG. 4 is a perspective view of Data Mining Process

FIG. 5 is a perspective view of Drug Information Processing.

FIG. 6 is a perspective view of Insurance Information Processing.

FIG. 7 is a perspective view of Drug Information Database.

FIG. 8 is a perspective view of Rule-based Decision Diagram.

### DESCRIPTION OF THE PREFERRED EMBODIMENTS

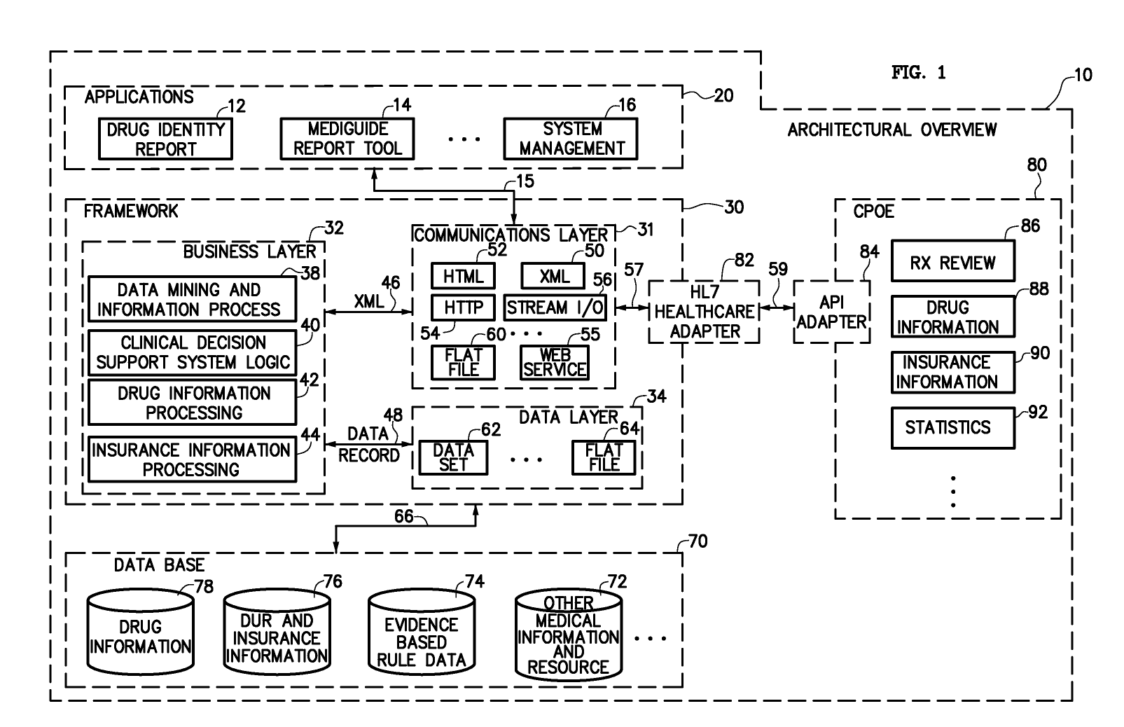

Generally, FIG. 1 shows a system overview that illustrates an integrated embodiment of MEGICS components in terms of data flow. The MEGICS management system is comprised of the following components: Architectural Overview 10, Applications 20, Framework 30, Database 70 and CPOE 80. These are connected via the data flow mechanism of each component. Application 10 contains the related software applications that are generated from the use of the MEGICS management system. It includes a Drug Identity Report Tool 12, a System Management Tool 16, and a Medication Guide Report Tool 14 that communicates with the Communications Layer 31 of the next component, Framework 30. Applications 10 can expand at the hospital level by addressing the needs for Hospital Pharmacy Administration and Hospital Management in Quality Assurance and Quality Control. Drug Identity Report 12 provides accurate information associated with the name of the drug: patient assignment, ingredients, efficacy, etc. For example, when a patient reports the use of additional over-the-counter drugs, this report will be utilized to ascertain whether the prescription drug is appropriate for the patient by checking for redundancies or possible side effects when taken with the aforementioned over-the-counter drugs. Mediguide Report Tool 14 outputs the printable instruction material for the prescription. The report includes name of the drug, directions for use, drug & disease information for patient (summary) and important notices for patient education. System Management 16 is a configuration tool that allows the user to manage the MEGICS management system settings. Framework 30 is a set of libraries or classes for MEGICS. It will be used to implement the designed structure of MEGICS applications. This set of libraries includes Business Layer 32, which includes a Data Mining and Information Processing Tool 38, Insurance Information Processing Tool 44, a Clinical Decision Support System Logics Tool 40, and a Drug Information Processing Tool 42. Data Layer 34 and the Communications Layer 31 are other libraries housed in Framework 30. The Communications Layer 31 can use HTML 52, XML 50, HTTP 54, Streaming I/O 56, Flat File 60 or Web Service 55 to allow defined communication among Business Layer 32 of Framework 30, Communications Layer 31 via XML 46, and Data Layer 34 via Data Record 48. Data Layer 34 is a layer to manage data that were primarily processed from their raw form to be suitable for service. Data Set 62 is a collection of data. Flat File 64 is free type of text document including non-standard dictated content. In Data Mining & Information Process 38, the collected data from MEGICS are utilized by analytic tools to generate prescription statistics, track prescription changes to the CDSM usage and log improvement ratios by mapping the code information in the diverse resources. Clinical Decision Support System Logic 40 is focused on using MEGICS-collected information to achieve reliable clinical advice for patient care based on pre-screened information generated from patient data and individual drug-specific logic. It provides information on medical conditions and drugs (by product and by ingredient). This process will be performed through the uniquely designed MEGICS knowledge database. By working with the clinician user, the system conducts a better analysis of patient data than either human or Clinical Decision Support System Logic 40 could do individually. Clinical Decision Support System Logic 40 outputs suggestions or a set of suggestions for the clinician to peruse, determine the most appropriate protocol and remove erroneous suggestions. Drug Information Processing 42 is a process to build up the drug database based on data value analysis of the various types of data collections from institutions, academic resources and insurance companies. These refined data are tailored to the user's requirements. Insurance Information Processing 44 functions to build up standards based on individual insurance information integrated with insurance and institution policies. These standards will be applied to adapt to the clinical practice area. Data flow 15 bridges communications between MEGICS Applications and Framework via proper communication data types in the Communications Layer. The Communications Layer 31 provides a proper data communication method that is suitable to the hospital computer system (CPOE). It includes Stream I/O 56, Flat File 60, Web Service 55, HTML 52, HTTP 54, XML 50 and so on. Communications Layer 31 is connected to Business Layer 32 by XML 46. Stream I/O 56 is a standard format and protocol for communication between modules. Flat File 60 is non-standardized text based document file (i.e. newspaper articles). Web service 55 is a communication channel between electronic devices and the public network. HTML 52 is a Hyper Text Mark-up Language that web browsers use to interpret and compose text, images and other material. HTML 52 is a type document for data delivery to the application. Hypertext Transfer Protocol (HTTP) 54 is a networking protocol for distributed, collaborative, hypermedia information systems. XML 50 is a set of rules for encoding documents in machine-readable form. Data flow 59 stands for CDSS & Drug information transfer by utilizing appropriate data conversion adapter in each entity. Data flow 57 shows properly interpreted healthcare data exchange between two entities. Database 70 is an organized medical data collection from diverse resources for easy management. The database will be for Drug Information 78, DUR and Insurance Information 76, Evidence Based Rule Data 74 and Other Medical Information & Resource 72. Drug Information 78 contains drug permit information, academic information for ingredients, and standard medication direction information. DUR and Insurance Information 76 is an insurance-related rule script that includes drug usage information and related rule-based logic. Evidence Based Rule Data 74 is a collection of data based on evidence-based rules. Other Medical Information and Resource 72 contains information resources for clinical practices such as disease information, medical journals and news, and terminology as necessary. CPOE 80 (Computerized Physician Order Entry) supports the Clinical Decision Support System (CDSS) to improve overall safety, quality and cost-effectiveness of healthcare services. It details Prescription Review 86, Drug Information 88, Insurance Information 90, and Statistics 92. Communication with Framework 30 is performed through API Adapter 84 and a HL7 Healthcare Adapter 82 connection. Rx Review 86 is a review of prescription information. Drug Information 88 contains drug permit information, academic information for ingredients, and standard medication direction information. Insurance Information 90 is an insurance-related rule script that includes drug usage information and related rule-based logic. Statistics 92 consists of the statistics related to drug prescription and usage data. API (Application Programming Interface) Adapter 84 is used to utilize system program from the 3^{rd} party system such as CPOE.

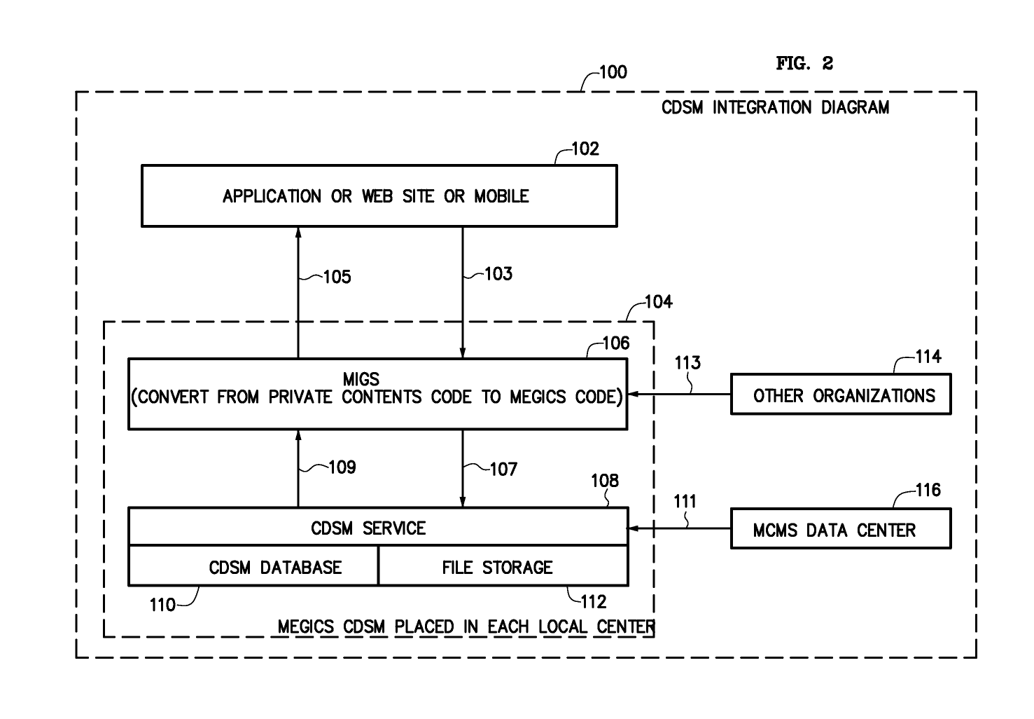

FIG. 2. details the CDSM (Clinical Decision Support Module) Integration 100 through a diagram that illustrates the diverse types of data resource flow. This block diagram further illustrates Clinical Decision Support System Logic 40 of the Framework 30 under Architectural Overview 10 in FIG. 1. By determining related dependencies or a common code, such as a unique key, MIGS 106 and CDSM 108 maintain a database with a schema that superimposes a logical structure on the data based on relationships between the different table elements. It is possible to arrange data into a logical structure that can be mapped into stored objects by MIGS 106 and CDSM 108 programming logic. It regularly extracts information from the structuralized medical contents database, generates a service database for MIGS and CDSM services, and updates users. In Application 102, information on using private contents codes can be requested via service call 103, or Web Service Call (SOAP), a direct call made with API (COM DLL) to MEGICS CDSM that is placed in each local center. The MIGS module 106 in MEGICS CDSM 104 receives the initiated request from the application. Within MIGS 106, the following items are carried out with the requested service: The data flow path 113 collects the information code of each institution 114 (by providing a managing tool to each provider) to establish connections among related codes and archives the information of each version. MIGS 106 then maps the collected codes to recognizable codes (e.g. FDA approval numbers). For information that cannot be automatically mapped, it provides a managing tool so that an expert can manually perform the mapping. MIGS 106 standardizes the collected information and presents it in a uniform format, summarizes existing standards, and supports the guidelines of different international standards, such as HL7, ISO/TC 215, CEN/TC 251, etc. Data flow path 107 is the request made through API to the CDSM service 108 that contains the CDSM database 110 and the file storage for contents 112. In the CDSM service 108, the medical information from MCMS 116 is streamed into the CDSM service module by data flow path 111. Based on the medical information, CDSM 108 formulates necessary responses, data flow path 109, as XML. The responses include checks for accuracy of each prescription, such as interaction, dosage, duplicate prescription, drug allergies, etc. MIGS 106 sends the finalized response 105 as XML with a style sheet to the Application 102

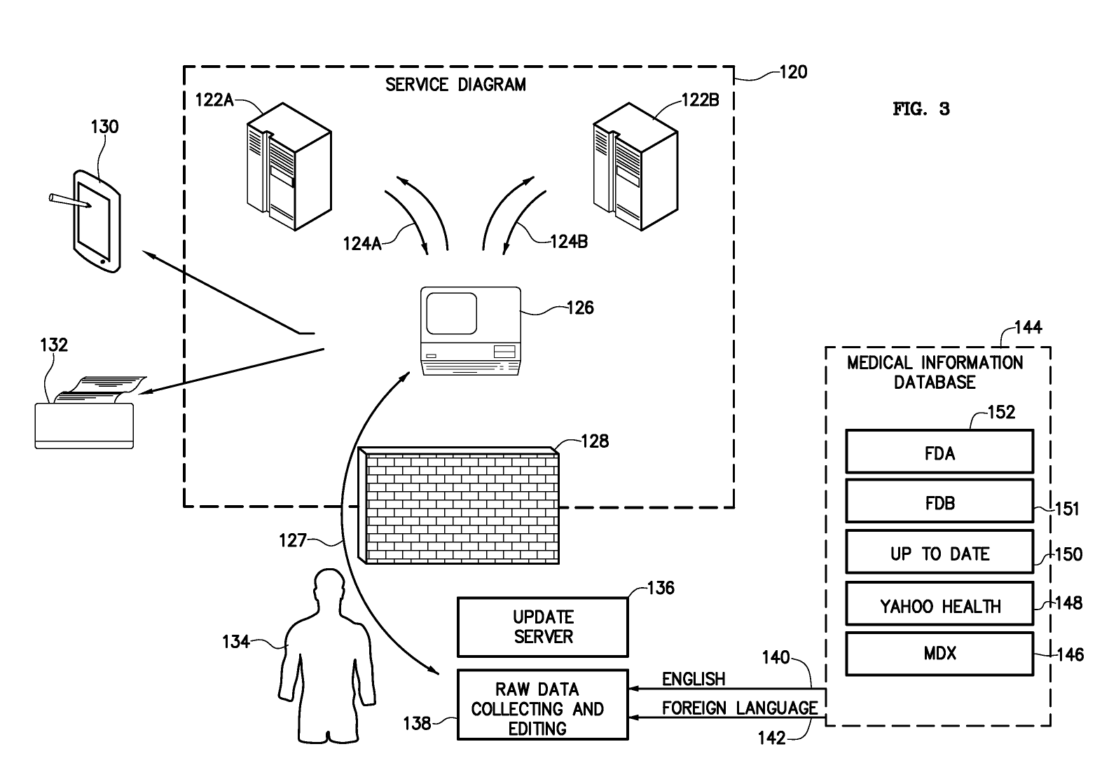

FIG. 3. Illustrates the MEGICS physical service diagram based on a MEGICS configured server. The MEGICS Information Center communicates through a firewall technology with the MEGICS Middleware Server. MEGICS System Server 126 is installed within Firewall 128 for safe security. The hand tool 130 represents one of diverse media tools for the service output, such as a hand-held PDA. The printer 132 stands for an output tool for the generation of instructions for medications or health-related notices. Server 122A depicts the user server (CPOE of a hospital or clinic) using MEGICS management system. Server 122B depicts the user server installed in-house for healthcare services overseen by the government entities, such as FDA and CDC. Data flow paths 124A and 124B illustrate communication for service requests (Ordering Info, Checking Drug List and others) and response from and to CDSM and MIGS service. MEGICS Middleware Server 126 is a server installed within the user firewall 128. A separate update server 136 for users is configured to update MEGICS server 126. Raw Data Collection and Editing 138 is the resource origin for collection of medical contents for service generation. Data flow path 127 represents an online drug code mapping service, live updates of drug & disease information, and a capture service for drug imaging between the MEGICS system and outside resources. Remote to the MEGICS Middleware Server 126 and the CPOE System is the MEGICS Information Center 144 and the Call Support Center 134. The CPOE can communicate with the CPOE client with TCP/IP protocols as web applications, web service as the APIcom.DDL, and HTTP protocol as web pages. CPOE at the facility 122A and the governmental entity for healthcare services 1228 communicate with MEGICS server 126 for services such as ordering drugs, checking drug inventory and others by activating CDSM and MIGS service 124A, 1243. The medical contents collected at the resource origin 138 are edited for MEGICS service and communicate with the MEGICS server that is in the user's firewall. The editing and information process utilizes the online drug code mapping service, live updates (of drug & disease information), and an image capture service for drugs. The system does not save any patient information on the server. There are various types of resources in the pool of medical information database 144. These are from the FDA (Food and Drug Administration) 152, Drug Information Framework® and resources from FDB (First Data Bank): an American medical information database service firm 151, Yahoo Health 148, UP-TO-DATE 150, MDX 146 from Thomson Reuters and others that can be utilized by MEGICS. The data can be moved in the form of English 140 or any other foreign language 142.

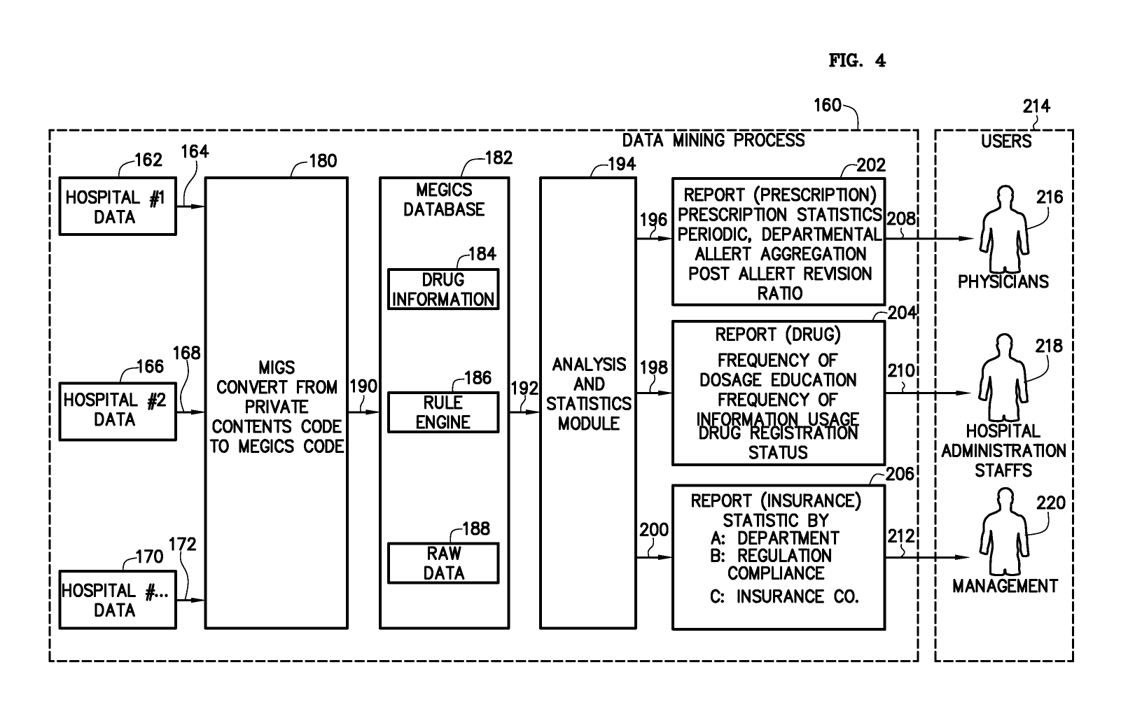

FIG. 4. illustrates the flow of how healthcare-related data is processed in the MEGICS management system and how necessary information is delivered to users. In addition to data retrieved from various hospitals, the depicted categories include data from many other available resources, such as pharmacies, insurance companies, and individual clinics. The block diagram illustrates the data mining process 38 at the Framework 30 under the Architectural Overview 10 in FIG. 1. The data mining process 160 explains how to collect the data and manage and analyze the MEGICS database. FIG. 4 consists of two distinct diagrams—one for the data mining process 160 and the other for various users 214. Hospital data 162, 166 and 170 indicate the sources of data collection from hospitals and other providers, such as pharmacies, insurance companies, and individual clinics. Data flow paths 164, 168 and 172 show the data flow from each provider to the MIGS box 180. MIGS (Medical Information Gateway Service) 180 collects the information code of each institution (by providing a managing tool to each provider) and archives the information. The collected information is standardized and presented in a uniform format through MIGS' 180 all-encompassing standard that supports various international versions (e.g. HL7, ISO/TV 215, CEN/TC 251, etc.). MIGS 180 can provide an information mapping service for information exchange between medical service providers by collecting online medical codes used by each institution and establishing connections among related codes. MIGS 180 maps the collected codes to recognizable codes (e.g. FDA approval numbers). For information that cannot be automatically mapped, it provides a managing tool so that an expert can manually perform the mapping at the institution. MIGS 180 collects the standard codes that are publicly accessible or can be redistributed, builds a database, and provides them to the user. It also manages and retains the mapping information comprised of different codes used by each institution and provides a data relaying service that enables data exchange among users. The user can manage its own code at the facility through the administrative tool that edits and manages the Private Medical Contents Code (user's own code). By providing the MEGICS CODE table, it enables the user to map the code manually. When managing each user's code, if a mapping of a standard code already exists, the user may utilize a function that enables automatic mapping for this code. For example, in the case of a drug code, if the user uses an FDA approval number, it is possible to map the approval number to the MEGICS CODE for that particular drug. It is possible to search for information from other facilities by using said mapping tool. This provides a service that enables information exchange between different systems or between different services. For example, when a patient examination data is remotely read by a user other than the one who ordered the examination, such as that of a video capsule endoscopy of Pillcam, it is possible to formulate a service to deliver the examination data to the accessing user and send the results through MEGICS using the patient's identification number. By synchronizing the database of the mapping information with the MEGIS Main Center (MCMS) on a real-time basis, it enables the MIGICS to play a role of an index server. Data flow path 190 shows the data flow from MIGS 180 to MEGICS Database 182. MEGICS Database 182 is a key information database to be utilized by users, and is the service standard of the MEGICS operation. It consists of three components—Drug Information 184, Rule Engine 186, and Raw Data 188. MEGICS Database 182 is analyzed at the separate module 194 to produce the required outcome in the form of three reports—Prescription Report 202, Drug Report 204, and Insurance Report 206. Drug Information 184 is a group of drug databases related to FDA approval, journals for content on the ingredients, dosage guide, etc. Rule Engine 186 is an engine that analyzes the collected data by applying the logics stored in the medical rule database. Raw Data 188 refer to information data related to MEGICS operation and are collected under MCMS guidelines. Data flow path 192 shows the data flow from MIGS 180 to MEGICS Database 182. Analysis and Statistics Module 194 shows a separate module that conducts the analysis and generates the requested reports for users. Data flow paths 196, 198 and 200 show report production flow from Analysis and Statistics Module 194 to the outcome of various reports 202, 204 and 206. Prescription Report 202 is generated from Analysis and Statistics Module 194, showing three contents such as prescription statistics, periodic and departmental ALERT aggregation and post ALERT revision ratio to be reviewed by hospital physicians or doctors at the individual clinics 216. Drug Report 204 is generated from Analysis and Statistics Module 194, showing three contents such as frequency of dosage education, frequency of information usage and drug registration status to be reviewed by the hospital administrative staff or administrators at individual clinics 218. Insurance Report 206 is generated from Analysis and Statistics Module 194, showing three contents such as statistic by hospital department, regulation compliance and insurance company to be reviewed by hospital management or the office manager at individual clinics 220. Users 214 are the report reviewers who are physicians 216, hospital administrative staff 218, and hospital management 220. Users 214 may include other personnel in cases of individual clinics, pharmacies, insurance companies, or drug companies.

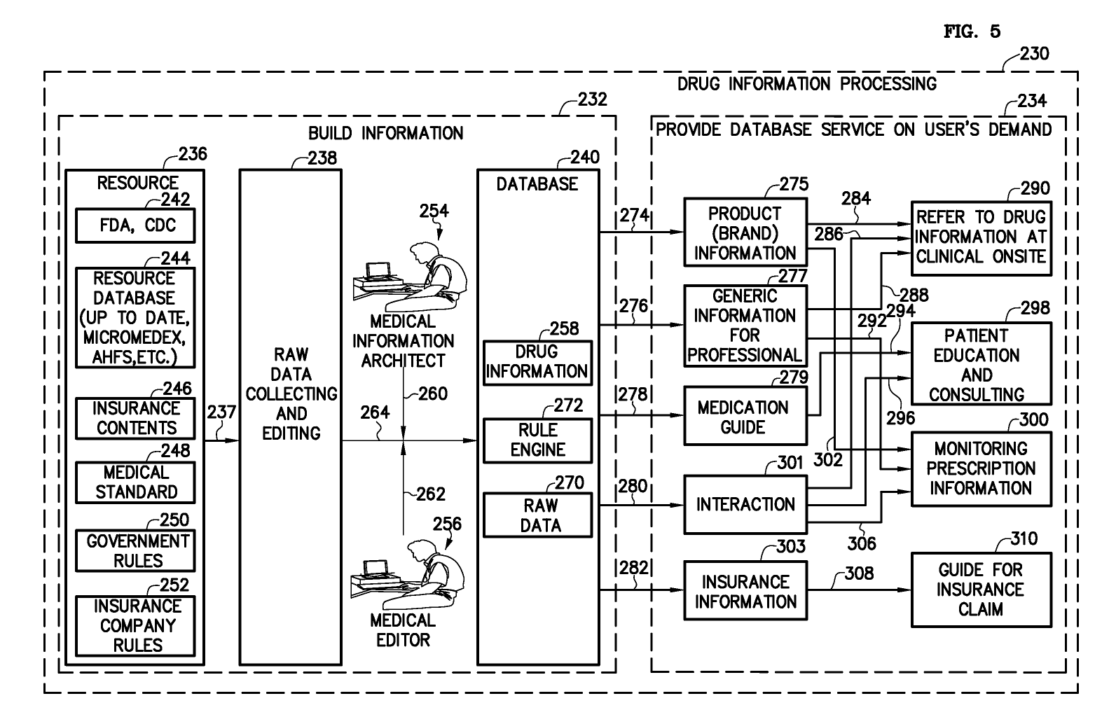

FIG. 5 displays a process block diagram of how the drug information resources are processed through MEGICS to generate user-demanded outcome. This block diagram illustrates drug information processing 42 of the Framework 30 under Architectural Overview 10 in FIG. 1. Drug information processing 230 explains how to collect, manage and update the drug information database related to insurance coverage and prescription. It consists of two subdiagrams—one for building information database and the other for providing database service for user's demand. Build information 232 is a diagram showing how to collect the drug data and build up the drug database. Providing database service for user's demand 234 depicts how to categorize the stored data and provide the outcome to users. Resource 236 shows various sources for collecting the verified data to build up the MEGICS database. FDA, CDC 242 represents the government sources of data collection. Resource Database 244 is a source of data collection, usually from private entities such as Up-to-date, Micromedex, AHFS, etc. Insurance Contents 246 is a source of data collection from insurance companies. Medical Standard 248 is a source of data collection from the medical field such as physicians group or individual disease association. Government Rules 250 consists of data gatherings regarding government guidelines and regulations. Insurance Company Rules 252 is a data collection of rules from the insurance companies. Data flow path 237 show the data flow from various data gathering resources to MCMS 238. Medical Contents Management System (Raw data collecting and editing) 238 collect medical information from specialized medical journals, company databases, or public resources; allow the collected information to be edited by medical service providers (physicians, pharmacists, nurses, etc.); and build a customized and structuralized medical contents database based on the revised information. Medical information architect 254 is a person who specializes in customizing the information and service to accommodate the user's requested design. Medical editor 256 is a person designated to manage the contents by building the information and criteria to update the contents. Data flow path 264 show the data flow from MCMS 238 to MEGICS Database 240. In the process, the data is analyzed, edited and customized by related personnel 254 and 256. Flow paths 260 and 262 show the input made by related personnel 254 and 256. MEGICS Database 240 is a key information database to be utilized by the users as the standard service of MEGICS operation. It consists of three components—Drug Information 258, Rule Engine 272 and Raw Data 270. MEGICS Database 240 can generate five items of categories—Product Information, Generic Information for Professionals, Medication Guide, Interaction and Insurance Information. Drug Information 258 represents the drug database containing FDA approval content, journal articles on drug compositions, dosage guides, etc. Rule Engine 272 is an engine that analyzes the incoming data by applying the logics stored in the medical rule database. Raw Data 270 is information data related to MEGICS operation that is collected under MCMS guidelines. Data flow paths 274, 276, 278, 280 and 282 show a distribution of the categorized data from Database 240 to various category items. Product (Brand) Information 275 is drug information which explains drug name, manufacturer, distributor, ingredients, efficacy, effectiveness, usage, dosage, precautious warnings, image and others. Generic Information for Professional 277 is ingredients information for the searched drug which shows component name, similar ingredient name, classification, efficacy, effectiveness, precautious warning and pharmacokinetics to the professionals. Medication Guide 279 is a handout information to be used by pharmacist in order to explain how to take, precaution and others to the patient. Interaction 301 is interaction information between two items such as drug-drug, drug-food, drug-disease and others. Insurance Information 303 is information related to insurance coverage for the prescribed medication. Data flow paths 284,302, 286, 288, 292, 294, 296,306 and 308 show the summarized output flow from five information categories to function levels 290, 298, 300 and 310. Refer to Drug Information at Clinical On-Site 290 is such a function that provides necessary information on the prescribed medication on real time basis at the point of care. Patient Education and Consulting 298 is a function provides necessary drug and disease information to enhance the patient's understanding. Monitoring Prescription Information 300 is a function that provides necessary drug information to monitor prescribed drug information such as dosage, duplicated prescription and possible interaction on real time at the point of prescription. Guide for Insurance claim 310 is such a function that provides necessary insurance guidelines for submission of insurance claims including insurance coverage and exclusions.

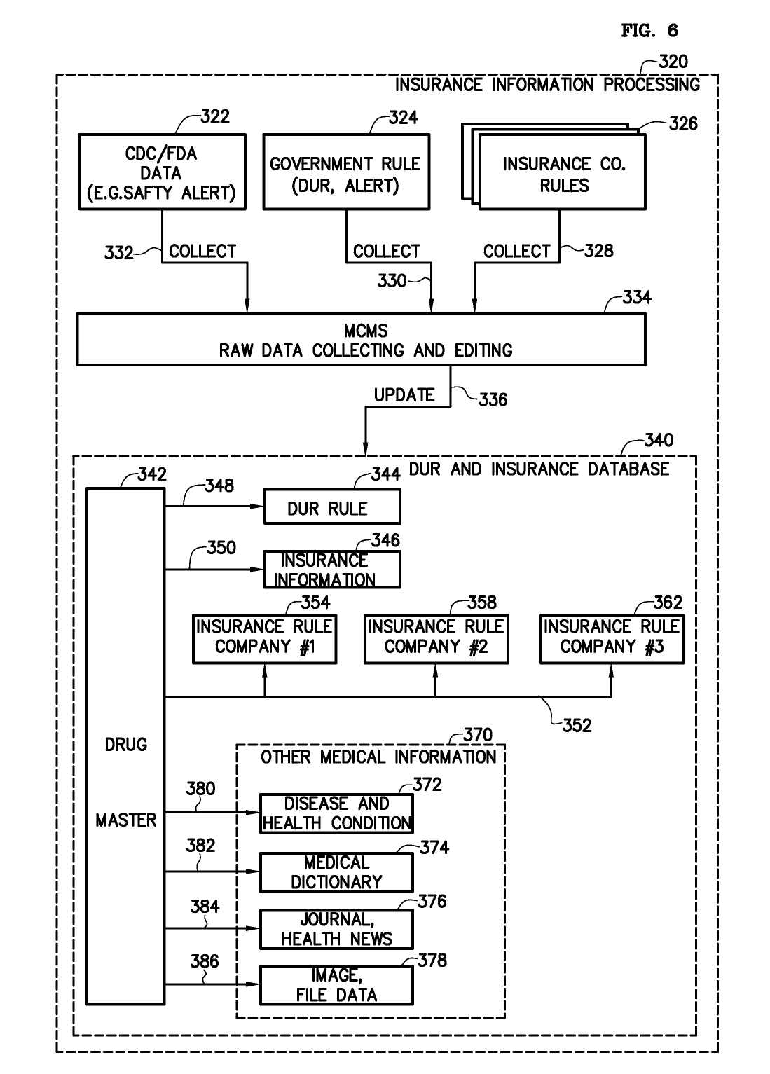

FIG. 6 illustrates how insurance information is processed and stored in the system as a database. The figure depicts the insurance information processing 320 at the Framework 30 under the Architectural Overview 10 in FIG. 1. It explains how to collect, manage and update the medical information database related to insurance coverage and prescription. CDC/FDA Data 322 is a group of databases related to guidelines for DUR and medical insurance provided by CDC or FDA. Government rule (DUR, Alert, etc.) 324 is a group of databases related to guidelines for DUR and medical insurance provided by government entities other than CDC and FDA. The Insurance Company Rules 326 are groups of databases related to guidelines for medical insurance provided by the insurance companies. Data flow paths 332, 330 and 328 show the data flows collected from various information resources to MCMS 334. Medical Contents Management System (MCMS) 334 collects medical information from specialized medical journals, database companies, or public resources; allows the collected information to be edited by medical service providers (physicians, pharmacists, nurses, etc.); and builds a customized and structuralized medical contents database based on the updated information. MCMS 334 builds and manages a database integrated with standard medical codes, including FDA, HL7, ICD-10, etc.; FDA approved drug information; and treatment-related information. It also maps the standard code of each institution already in its unique database to MEGICS' own code, and builds a base database for the information gateway. MCMS 334 regularly extracts the information from the structuralized medical contents database, generates a service database for MIGS and CDSM services, and updates the users. Information on diseases, drugs (generic and product), medication guides, and interactions (drug-drug, drug-food and drug-disease) is being built and continuously updated as services are provided. DUR and Insurance Database box 340 is a structure of the database to offer drug and insurance information to users in a timely manner. The database of DUR and Insurance 340 are prepared for an environment where various items can be added and changed by storing the text-based information in an easily adaptable XML Document format. It assigns unique item codes with serial numbers to all contents. Drug master 342 is a master database related to drug information. Data flow paths 348, 350, 352, 380, 382, 384, and 386 show the data flows from drug master 342 to each category listed in the diagram. DUR rule 344 is a verification rule to be programmed based on the drug usage rule. Insurance information 346 contains both distinctive and common data of insurance companies and their insurance policies or plans. Insurance company rule boxes 354, 358, and 362 indicate a possible build-up of a separate database for each company when an insurance company intends to apply its own rules. Data flow path 352 indicates such a possible separate connection with each insurance company based on different rules. Other medical information 370 is other relevant medical data used and incorporated with drug master 342. Disease and health condition 372 is the information collected from patients. Medical dictionary 374 is a reference book used for explaining medical terminology. Journal, health news 376 is for publications of current events and trends in the medical field. Image, file data 378 is for open and public information relevant to the medical field collected from websites or print publications.

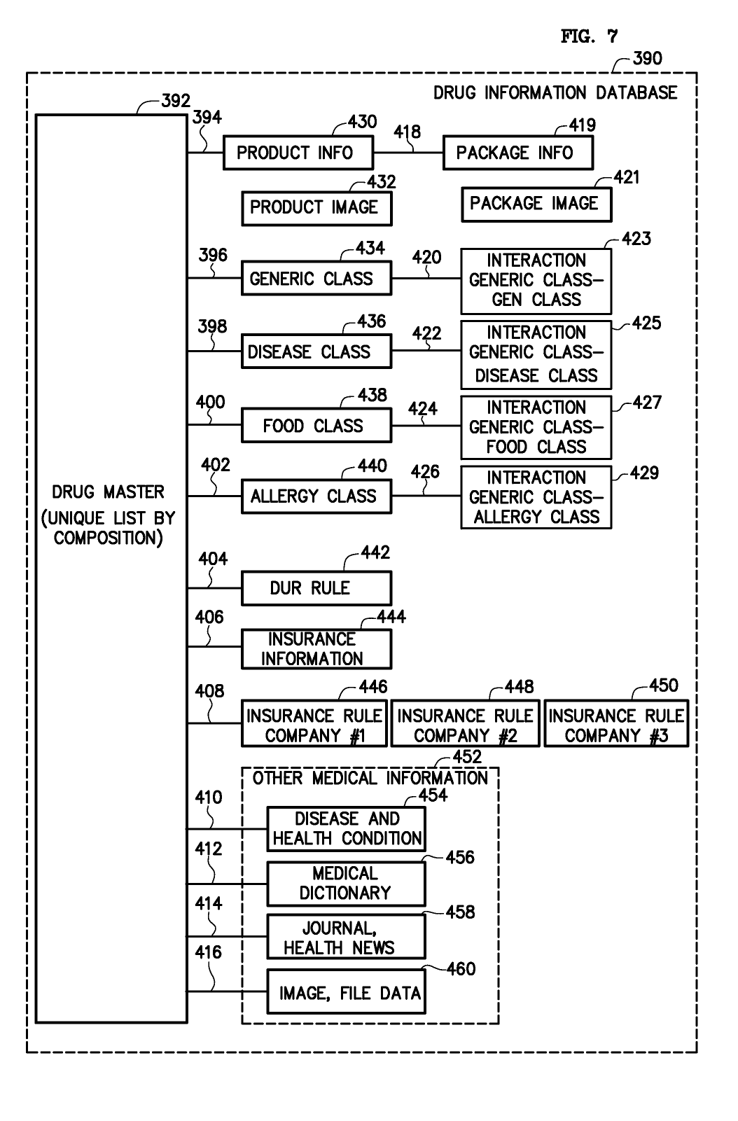

FIG. 7 illustrates how the drug information database is constructed and shows items, class, rules and relations. It shows a block diagram that further illustrates the drug information 78 at the Database 70 under the Architectural Overview 10 in FIG. 1. It explains how to collect, manage and update the drug information database 390. Since the information associated with a single drug item is provided in various ways, it is more efficient to manage the information by the following four levels: 1) Information at product level, 2) Information at packaging level, 3) Information at single ingredient level, and 4) information at compound ingredient level. In the management of the interaction data, the database first bundles categories of interactions by class, then manages and outputs the information. For example, for information on drug-drug Interaction, the database will verify the information in the order of: Product1→Generic1→Generic Class1<−>Generic Class2←Generic2←Product2, then output the information requested. Drug information will be collected in one of three ways: (1) by developing a managing tool for drug information (dynamic Wikipedia-type format), (2) purchasing the relevant information from outside references to add to the database, or (3) editing existing information to compile a master information database. Potential outside references are a) FDA Approval Letter (FDA approval information is open to the public), b) drug insert (written explanation provided by pharmaceutical companies). Other major drug information resources will be a) Thomson Reuters Micromedex (http://www.micromedex.com), b) UpToDate (http://uptodate.com), c) AHFS Drug Information (http://www.ahfsdruginformation.com/), d) Lexicomp—Drug Information Handbook (http://www.lexi.com) and e) Yahoo Health. The database of drug master 392 is prepared for an environment where various items can be added and changed by storing the text-based information in an easily adaptable XML Document format. It assigns a unique item code with a serial number to all contents. Drug information database box 390 is a structure of the database to offer timely drug information to the users. Drug master 392 is a master database related to the drug information. Connecting lines 394, 396, 398, 400, 402, 404, 406, 408, 410, 412, 414 and 416 show the relevant relationship between drug master 392 and each category listed in the diagram. Connecting lines 418, 420, 422, 424 and 426 show the relevant relationship between the class column and interaction column. Product information 430 is basic drug information including brand name, name of the pharmaceutical companies, indigents of the drug, FDA permit number or other data. Product image 432 is the image of the drug in the form of package or individual tablet. Generic class 434 is a group of common ingredients among variations of the drug. Disease class 436 is a group of common diseases that shows similar symptoms. Food class 438 represents food items that share common ingredients. Allergy class 440 is a group of ingredients that can cause similar allergic reactions. DUR rule 442 is a verification rule to be programmed based on drug usage rule. Insurance information 444 is insurance information data that are specific or common in nature by the insurance companies. Insurance company rule boxes 446, 448 and 450 indicate a possible build-up of separate databases for each company when an insurance company is intended to apply its own rules. Data flow path 408 indicates such a possible separate connection with each insurance company. Other medical information 452 denotes other relevant medical information data to be used and incorporated with drug master 392. Disease and health condition 454 is the information to be collected from the patients. Medical dictionary 456 is a reference book to be used for explaining medical terminology. Journal, health news 458 is a publication of current events and trends in the medical field. Image, file data 460 is open and public information relevant to medical field to be collected from web sites or publications.

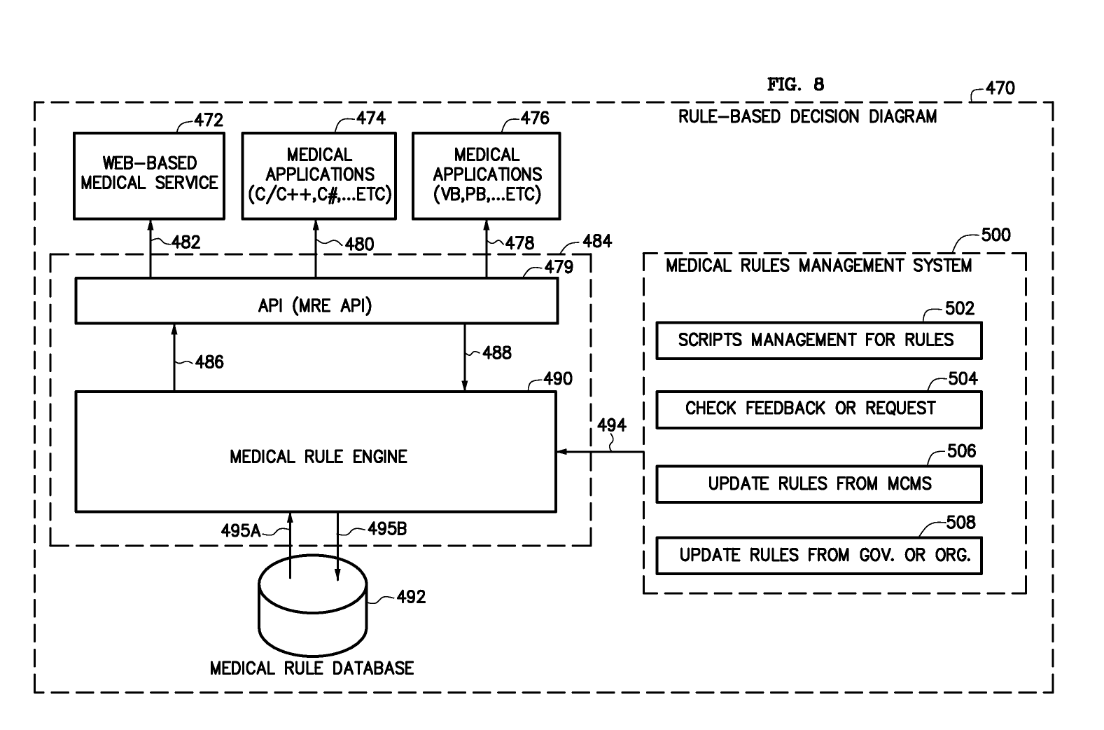

FIG. 8 shows a block diagram that illustrates the evidence based rule data 74 at the Database 70 under the Architectural Overview 10. The MEGICS management system utilizes the medical rule engine 490 to build a database for script-based logic. Medical rule engine 490 is a software system that executes one or more operational rules in a runtime production environment. Rule engine software is commonly provided as a component of a business rule management system, which, among other functions, provides the ability to: register, define, classify, and manage all the rules; verify consistency of rules' definitions; define the relationships between different rules; and relate some of these rules to IT applications that are affected or need enforcement of one or more of these rules. The rule-based decision essentially consists of rule editing, API module, and database. There are various methods for recording the rules by utilizing Script, such as Javascript, C#, and Arden Syntax. The MEGICS management system employs a new approach of HL7 by benchmarking Arden Syntax. When the medical rules are requested during the operation of the MEGICS management system, the software system provides the user with the medical rules applicable to the present service environment. This Medical Rule Engine (MRE) 490 consists of three other components: 1) Medical Rule Management System 500, 2) Medical Rules database 492, and 3) Medical Rules Engine Application Programming Interface 479. There are several types of rules to be applied: 1) dosage check, 2) interactions check, 3) duplicate check, and 4) error in diagnostics and treatment check. These rules are an integral part of the MEGICS management system, as they ensure the production of reliable outputs from the database. These rules expand during the course of operations in accordance with the user's demand. Web-based medical service 472 is a possible type of software program developed through the MEGICS management system that is either a portal or web service. Medical applications 474 are the types of potential software programs developed though the MEGICS management service for general application. Medical applications 476 are the types of the possible software programs developed though the MEGICS management service with a tool of COM. 484 is an Interface used when the program is being developed by the user, who utilizes the modules provided by the MEGICS management system. Data flow path 482 indicates Simple Object Access Protocol (SOAP), which is the communication guideline among the entities to actively use web service. Data flow path 480 indicates WIL DLL, which is used by the Windows-based program developer. Data flow path 478 indicates Com DLL, which is used by the program developer with C#, VB, Delphi, and other languages. Data flow path 486 indicates the data flow of the updated rules from Medical rule engine 490. Data flow path 488 indicates the data flow for Feedback or Request from API 479. Medical rule engine 490 is an engine that analyzes the incoming data by applying the logics stored in the Medical rule database 492. Data flow paths 495a and 495b show two-way data flows between Medical rule engine 490 and Medical Rule Database 492. Medical rule database 492 is for storage that includes the database converted from the logics related to medical diagnostic guidelines. Data flow 494 indicates the live update from the Medical rules management system 500. Medical rules management system 500 is a system that controls the four kinds of rule databases. Scripts management for rules 502 is the management of the script representing the logics. Check feedback or request 504 is a function to process the user's feedback or request. Update rules from MCMS 506 is a function to update the medical rules from the management database. Update rules from government or organization 508 is a function to update the guidelines or regulations from the government or organization.

I claim:

1. A system for reviewing information and patient biometrics, and having the capability to update medical records, said system comprising:
a healthcare management system having a framework that includes a business layer, a communicational layer, a data layer and a healthcare adapter, said healthcare adapter designed to establish electrical and data communication with a hospital computer system;
said business layer have plurality of information processing instructions;
said communications layer utilizing XML technology to communication data between said business layer and said communications layer,
said healthcare management system includes a means for establishing electrical and data communication between said communications layer with a plurality of applications; and
said healthcare management system including a means to establishing electrical and data communication between said data layer with a plurality of databases.

2. A system for reviewing information and patient biometrics as recited in claim 1, where said plurality of databases includes a drug information database, a DUR and insurance information database, an evidence and rule-based database and another medical information and resources database.

3. A system for reviewing information and patient biometrics as recited in claim 1, wherein said communications layer utilizes Stream I/O, Flat File, Web Service, HTML, HTTP, XML protocols for communicating with said healthcare adapter.

4. A system for reviewing information and patient biometrics as recited in claim 1, wherein said applications includes one or more drug identity reports, a MediGuide reports, system management reports and others such as Hospital Pharmacy Administration report and Hospital Management report in Quality Assurance and Quality Control.

5. A system for reviewing information and patient biometrics as recited in claim 2, wherein said evidence and rule-based database includes a medical rule engine that has an electrical and data communication with a medical rule database, a medical rules management system, and a API adapter that has an electrical and data communication with a web-based medical service, and medical applications.

6. A system for reviewing information and patient biometrics as recited in claim 2, wherein said drug information database includes information from the FDA, CDC, insurance contents, medical standards, government rules, insurance company rules, and resource database.

7. A system for reviewing information and patient biometrics as recited in claim 6, wherein said drug information database provides information upon a user's demand the includes information on a product, generic information for a professional, medication guide, interactions among food, drug and disease, insurance information, drug information at clinical or hospital site, patient drug literature, education and consulting, guide for insurance claims, and monitoring means for prescription information.

8. A system for reviewing information and patient biometrics as recited in claim 6, wherein said drug information database includes a master list that provides data on the product including package information, a product image, generic classification including interactions, disease classification including interactions, food classification including interactions, allergy classification including interactions, DUR rules, insurance information, and other medical information including disease and health conditions, medical dictionary, journal health news.

9. A system for reviewing information and patient biometrics as recited in claim wherein said business layer includes a data mining and information process, a clinical decision support system logics, drug information processing, and insurance processing information.

10. A system for reviewing information and patient biometrics as recited in claim 9, wherein said data mining process includes an analysis and statistical module that communicates database information in reports for physicians, hospital staff and management review.

11. A system for reviewing information and patient biometrics as recited in claim 1, wherein a means to upload updated versions of the executables and new system requirement specifications and databases can be accomplished either manually or automatically locally or remotely.

12. A system for reviewing information and patient biometrics as recited in claim 1, wherein the at least one computer system is located at a healthcare facility, wherein the system further comprises software executing on said processor for providing the medical data to the healthcare facility computer.

13. A system for reviewing information and patient biometrics as recited in claim 1, wherein said computer has a means to apply a time and date stamp on the data, compliance status, exceptions, system network configuration, identity and number of computers and access.

14. A system for reviewing information and patient biometrics as recited in claim 1, wherein access to said computer system requires a pass code whereby said pass code is a unique alphanumeric series of digits.

15. A system for reviewing information and patient biometrics as recited in claim 1, Provides a validated data collection by building refined relationships in the data mining process among diverse data resources, such as unknown patterns and unknown records.

16. A system for reviewing information and patient biometrics as recited in claim 1, wherein said system provides expandability and accessible methods, such as use of portable home health devices for initial preliminary self-treatment which can be added to the management system.

17. A system for reviewing information and patient biometrics as recited in claim 1, wherein said system provides excellent data security due to non-transmission of personal information to outside sources.

18. A system for reviewing information and patient biometrics as recited in claim 1, wherein said system is compatible with PC, Mac, and mobile devices due to its web service-based model.

19. A system for reviewing information and patient biometrics as recited in claim 1, wherein said system permits a user to access and review a consolidated up-to-date treatment and drug database and make informed treatment decisions.

20. A system for reviewing information and patient biometrics as recited in claim 1, wherein said system enables healthcare providers to offer optimum treatments for more accurate diagnoses of patients' state via the intricate mapping and data mining of patient history, prescription, treatment and health condition information.

21. A system for reviewing information and patient biometrics as recited in claim 1, wherein said system can be implemented to the existing clinical or hospital mainframe system by providing a module that matches the different coding or standards of the user's program with the specific code or language.
